(19) United States
(12) Patent Application Publication
(10) Pub. No.: US 2023/0250839 A1
(43) Pub. Date: Aug. 10, 2023

(54) LOCKPIN CONNECTION AND METHOD

(71) Applicant: Goodrich Actuation Systems Limited, Solihull (GB)

(72) Inventors: Karolis BUTRIMAVICIUS, Wolverhampton (GB); Paul SMITH, Benthall (GB); Mark David TIMMS, Wolverhampton (GB)

(21) Appl. No.: 18/165,549

(22) Filed: Feb. 7, 2023

(30) Foreign Application Priority Data
Feb. 7, 2022 (EP) 22275012.7

(51) Int. Cl. F16B 7/04; F16B 7/18

(52) U.S. Cl. CPC F16B 7/042; F16B 7/18

(57) ABSTRACT

An actuator arrangement includes an actuator screwshaft configured to receive a female connector, a lockpin having a male connector that is connected to the female connector. When the actuator screwshaft is rotated, in use, the lockpin is configured to move from a first position to a second position.

### CROSS-REFERENCE TO RELATED APPLICATIONS

This application claims priority to European Patent Application No. 22275012.7 filed Feb. 7, 2022, the entire contents of which is incorporated herein by reference.

### TECHNICAL FIELD

This disclosure relates to a connection and method of operating a lockpin—for example, a lockpin provided on a foldable wing tip.

### BACKGROUND

Foldable wings are used in aviation to increase the efficiency of an aircraft. These wings are locked ‘in-flight’ by load bearing lockpins to prevent the wing from moving. For maintenance purposes, the lockpin needs to be accessible and easily removed in case of damage or replacement.

There is a need for improved lockpin arrangements on foldable wings that are reduced in size and easily removable for maintenance purposes.

### SUMMARY

In one aspect, there is provided an actuator arrangement that includes an actuator screwshaft configured to receive a female connector, a lockpin having a male connector that is connected to the female connector. When the actuator screwshaft is rotated, in use, the lockpin is configured to move from a first position to a second position.

Further, the first position may be a locked position or an unlocked position, and the second position may be a locked position when the first position is an unlocked position, or an unlocked position when the first position is a locked position.

Further, the lockpin may include a first end and a second end, wherein the second end may include a recess configured to receive a protrusion of the male connector, and wherein the second end may include a shoulder portion. When moving the lockpin from the locked position to the unlocked position, the female connector may be configured to contact the shoulder portion of the second end of the lockpin, and the female connector may be configured to apply a force to the shoulder portion to move the lockpin from the locked position to the unlocked position. When moving the lockpin from the unlocked position to the locked position, the protrusion of the male connector may be configured to contact the shoulder portion of the second end of the lockpin, and the protrusion of the male connector may be configured to apply a force to the shoulder portion to move the lockpin from the unlocked position to the locked position. When the lockpin is in a locked position, the recess and shoulder may be configured to allow radial movement of the lockpin to prevent load transfer to an actuator housing.

In another aspect, there is provided a kit for connecting a lockpin to an actuator arrangement. The kit includes an actuator arrangement having a female connector and a lockpin having a male connector configured to connect to the female connector.

Further, the male connector may include at least one hook and the female connector may include at least one opening and at least one groove. The at least one opening and the at least one groove may be configured to receive the at least one hook of the male connector. The female connector may include at least one spring configured to bias the at least one hook of the male connector to the at least one groove of the female connector.

The kit may further comprise a tool configured to connect the male connector to the female connector. The tool may include a first end and a second end, and the first end may be configured to receive the male connector. Further, the lockpin may further comprise a central bore, and the first end of the tool may be configured to insert the male connector through the central bore of the lockpin to mate with the female connector of the actuator arrangement. The tool may include a handle that is configured to rotate the tool such that the male connector connects to the female connector.

In another aspect, there is provided a method of connecting a lockpin to an actuator arrangement. The method includes providing a tool having a first end and a second end, wherein the tool receives a male connector at the first end, moving the first end of the tool through a central bore of a lockpin such that the male connector engages with the female connector, rotating the tool such that the male connector rotates to retain its position in a groove provided in the female connector, and removing the tool.

Further, the male connector may include at least one hook and the female connector may include at least one opening and at least one groove. The at least one opening and the at least one groove may be configured to receive the at least one hook of the male connector, wherein, when the male connector engages the female connector, the at least one hook of the male connector moves through the at least one opening of the female connector, and wherein, during rotation, the at least one hook of the male connector rotates into the at least one groove of the female connector. The female connector may include a spring that biases the at least one hook of the male connector against the at least one groove of the female connector.

### BRIEF DESCRIPTION OF THE DRAWINGS

The following descriptions should not be considered limiting in any way. With reference to the accompanying drawings, like elements are numbered alike:

FIG. 1a shows a prior art lockpin;

FIG. 1b shows a further example of a prior art lockpin;

FIG. 2 shows an example of a lockpin and lockpin connection;

FIG. 3a shows a view of a tool for allowing connection of the lockpin of FIG. 2;

FIG. 3b shows another view of the tool of FIG. 3a;

FIG. 4a shows a view of a lockpin connection in use; and

FIG. 4b shows another view of the lockpin connection of FIG. 4a in use.

### DETAILED DESCRIPTION

A detailed description of one or more embodiments of the disclosed apparatus and method are presented herein by way of exemplification and not limitation with reference to the Figures.

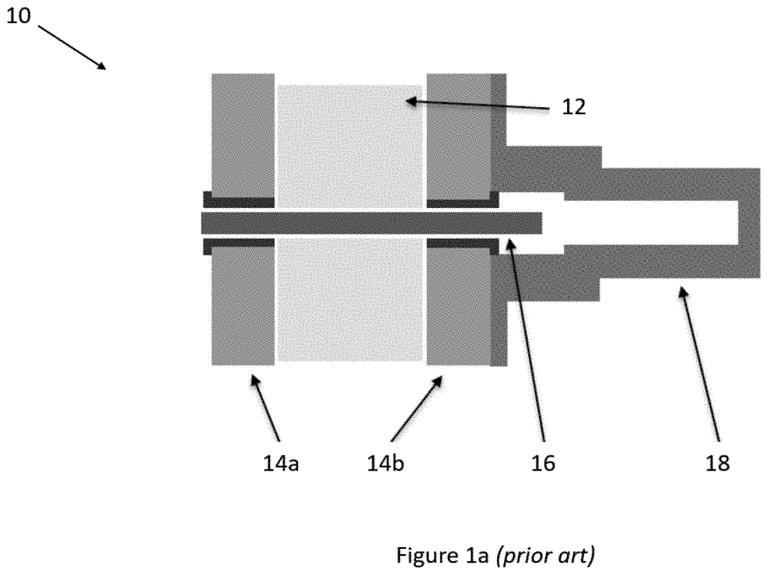

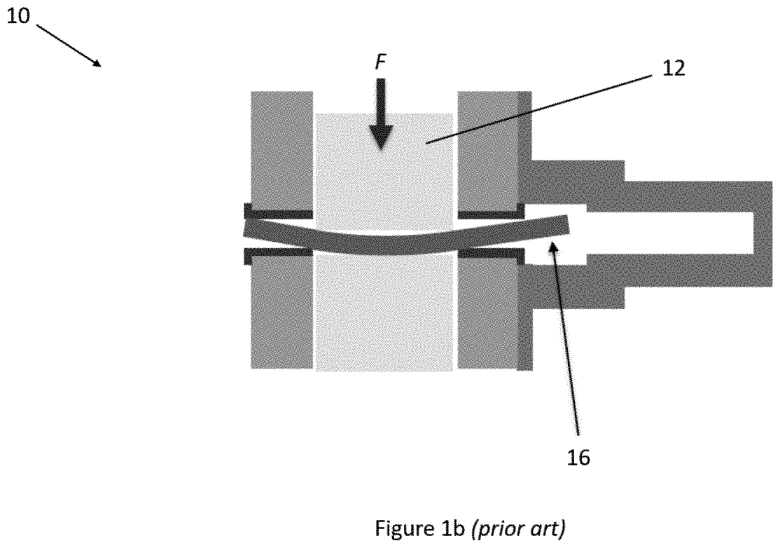

FIG. 1a shows a prior art example of a lockpin in a foldable wing. The lockpin arrangement is shown generally by 10 in FIG. 1a. The arrangement includes a lockpin 16, a foldable tip spar lug 12, wing spar lugs 14a and 14b, and an actuator body 18. As can be seen in FIG. 1a, the lockpin 16 extends through the foldable tip spar lug 12 and the wing spar lugs 14a and 14b. The lockpin 16 extends into the actuator body 18 in use.

FIG. 1b shows the lockpin arrangement 10 when a force, F, is applied to the foldable tip spar lug 12, in use. As can be seen in FIG. 1b, the load applied by force F on the lockpin 16 can cause the lockpin 16 to deform and move axially and/or radially out of place. This can create high indeterminate loads that are transferred to the actuator body which may cause in damage to the overall system.

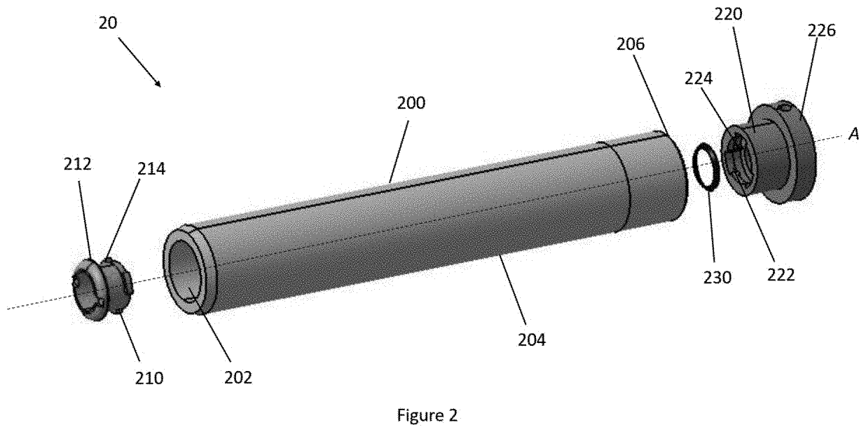

FIG. 2 shows an exploded view of an example of a lockpin arrangement, shown generally as 20. The lockpin arrangement 20 includes a lockpin 200 having a first end 202 and a second end 206. The lockpin 200 includes a lockpin body 204 that extends along a longitudinal axis, A, from the first end 202 to the second end 206. At the first end 202, there is provided an opening and the lockpin 200 includes a central bore extending from the first end 202 to the second end 206.

As shown in FIG. 2, a male connector 210 may be provided at the first end 202 of the lockpin 200. The male connector may include a protrusion 212 and may include at least one hook 214 provided on an opposite end of the protrusion 212. A female connector 220 is provided at a second end 206 of the lockpin 200. The female connector 220 may include at least one opening 222 sized and shaped to receive the at least one hook 214 of the male connector 210. The female connector 220 may also include at least one groove 224 sized and shaped to receive the at least one hook 214 of the male connector 210. There may be provided a spring 230 to assist with the insertion and biasing of the male connector 210 in use. Although the spring 230 is shown away from the female connector 220, it is envisaged that the spring 230 will be provided in the female connector 220 between the at least one groove 224 and a first end 226 of the female connector 220. During insertion of the male connector 210, the spring 230 compresses to allow the at least one hook 214 to enter the at least one opening 222 of the female connector 220 such that the at least one hook 214 enters the at least one groove 224 of the female connector 220. The male connector 210 is then rotated around the longitudinal axis A such that the at least one hook 214 is maintained in the at least one groove 214. The spring 230 would then decompress to ensure that the male connector 210 is biased against the at least one groove 214 for robust connection of the male connector 210 to the female connector 220.

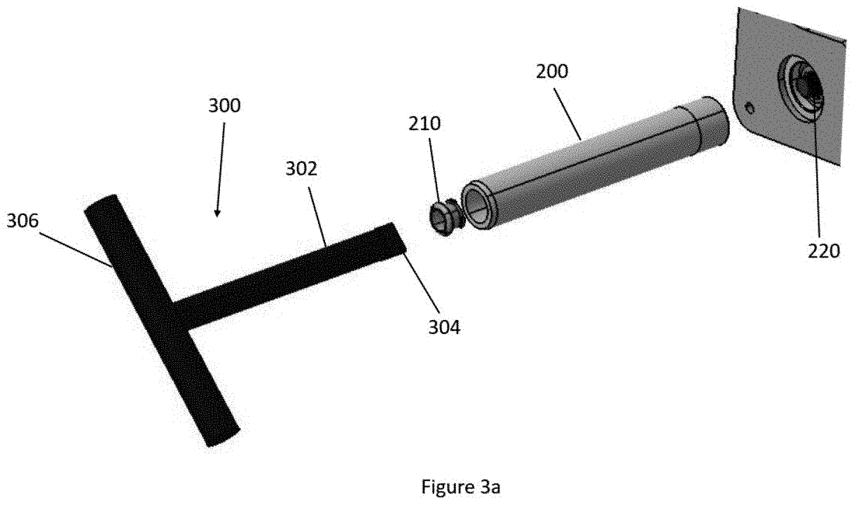

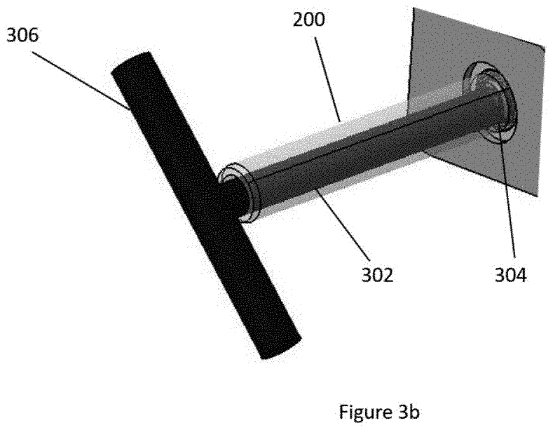

Referring now to FIGS. 3a and 3b, there is shown generally a tool 300 for connecting the male connector 210 with the female connector 220. The tool 300 may include a longitudinal body 302 having a first end 304 and a second end 306. The second end 306 of the body 302 may be formed as a handle 306 that extends perpendicular from the longitudinal axis of the lockpin 200. The handle 306 therefore allows for rotation of the tool 300 to connect the male connector 210 to the female connector 220. The first end 304 is adapted to mate with the male connector 210 for insertion through the lockpin 200 and into the female connector 220. As can be seen in FIG. 3b, the longitudinal body 302 of the tool 300 is sized and shaped to be able to introduce the male connector 210 through the central bore of the lockpin 200 such that the male connector 210 reaches the second end 206 (shown in FIG. 2) of the lockpin 200. Referring to FIGS. 2, 3a and 3b, during insertion of the male connector 210, by the tool 300, the spring 230 compresses to allow the at least one hook 214 to enter the at least one opening 222 of the female connector 220 such that the at least one hook 214 enters the at least one groove 224 of the female connector 220. The male connector 210 is then rotated around the longitudinal axis A, e.g. by rotation of the tool 300 through the handle 306, such that the at least one hook 214 is maintained in the at least one groove 214. After insertion, the spring 230 then decompresses to ensure that the male connector 210 is biased against the at least one groove 214 for robust connection of the male connector 210 to the female connector 220.

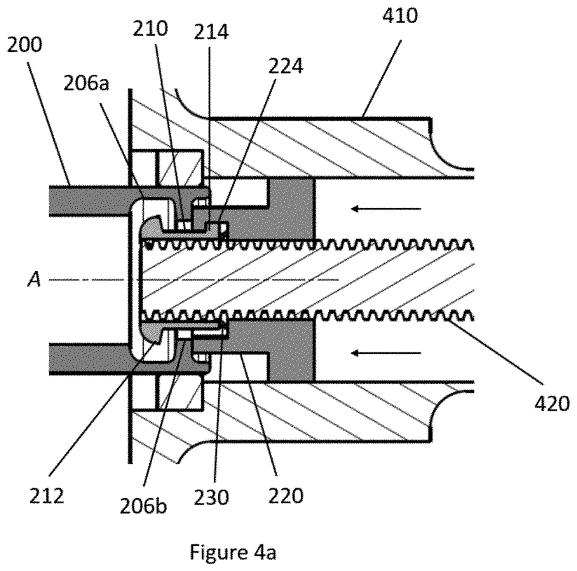

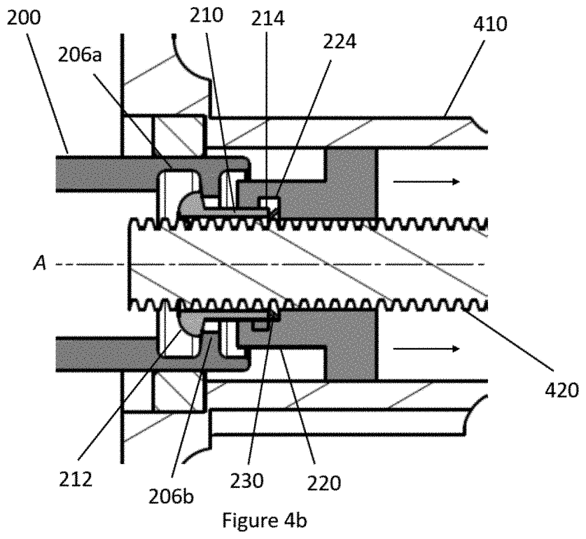

Referring now to FIGS. 4a and 4b, these Figures show the lockpin in use when connected in an actuator arrangement. For consistency, the reference numerals used above are present when referring to like-for-like parts, with additional reference numerals for further details.

As shown in FIG. 4a, there may be provided an actuator housing 410 and an actuator screwshaft 420. A screwshaft′ is to be understood to be a shaft that includes a screw thread. As can be seen in this Figure, the female connector 220 (i.e., the female connector 220 shown in FIG. 2) is received on the actuator screwshaft 420. For example, the actuator screwshaft 420 may have a thread portion that contacts a thread portion of the female connector 220 (e.g. on an inner surface of the female connector 220). As shown in FIG. 4a, the male connector 210 is already mechanically connected to the female connector 220. For example, the male connector 210 may have been introduced through the lockpin 200 as described above in relation to FIGS. 3a and 3b. As is further shown in FIG. 4a, the second end 206 (shown generally in FIG. 2) of the lockpin 200 may include a recess 206a that is configured to receive the protrusion 212 of the male connector 210. The second end 206 (shown generally in FIG. 2) may also include a shoulder portion (e.g. a protrusion) 206b. The recess 206a and the shoulder portion 206b allow for the protrusion 212 of the male connector 210 to move in a longitudinal direction within the recess 206a (i.e. in a direction along the longitudinal axis A). As described above, and as shown in FIG. 4a, the at least one hook 214 of the male connector 210 is received in the at least one groove 224 of the female connector 220. The spring 230 of the female connector 220 biases the at least one hook 214 of the male connector 210 to the at least one groove 224 of the female connector 220. Therefore, the male connector 210 and female connector 220 are connected. As the actuator screwshaft 420 rotates, the female connector 220 may translate along the actuator screwshaft 420 in a longitudinal direction (i.e., in a direction along the longitudinal axis A). As shown in FIG. 4a, the actuator screwshaft 420 is rotated such that the female connector 220 may move in the direction of the arrows (e.g. to the left of the page). This may be known also as a load path when unlocking a foldable wing tip, for example. During unlocking, the female connector 220 moves along the actuator screwshaft 420 to contact the shoulder portion 218 of the lockpin 200. The force of the female connector 220 contacting the shoulder portion 218 of the lockpin 200 moves the lockpin 200 to an unlocked position (i.e., the lockpin 200 moves also in the direction of the arrows—for example, to the left of the page).

FIG. 4b shows the arrangement of FIG. 4a, in use, in the opposite direction for, for example, a locking procedure. As with FIG. 4a, the rotation of the actuator screwshaft 420 such that the female connector 220 may translate along the actuator screwshaft 420 in a longitudinal direction (i.e., in a direction along the longitudinal axis A). The male connector 210 and female connector 220 are connected as described above in relation to FIG. 4a, where the same components are shown. As shown in FIG. 4b, the actuator screwshaft 420 is rotated such that the female connector 220 may move in the direction of the arrows (e.g. to the right of the page). This may be known also as a load path when locking a foldable wing tip, for example. During locking, the female connector 220 moves along the actuator screwshaft 420 and, as the male connector 210 is connected to the female connector 220, the male connector moves in the same direction. The protrusion 212 of the male connector 210 moves within the recess 206a of the lockpin such that the protrusion 212 of the male connector 210 contacts the shoulder portion 218 of the lockpin 200. The force of the protrusion 212 of the male connector 210 contacting the shoulder portion 218 of the lockpin 200 moves the lockpin 200 to a locked position (i.e., the lockpin 200 moves also in the direction of the arrows—for example, to the right of the page). When the lockpin 200 is in a locked position, the recess 206a and shoulder portion 206b allow for radial movement of the lockpin 200 to prevent load transfer to the actuator housing 410.

Although this disclosure has been described in terms of preferred examples, it should be understood that these examples are illustrative only and that the claims are not limited to those examples. Those skilled in the art will be able to make modifications and alternatives in view of the disclosure which are contemplated as falling within the scope of the appended claims.

1. An actuator arrangement, comprising:
an actuator screwshaft configured to receive a female connector; and
a lockpin having a male connector, wherein the male connector is connected to the female connector;
wherein, when the actuator screwshaft is rotated, in use, the lockpin is configured to move from a first position to a second position.

2. The actuator arrangement of claim 1, wherein the first position is a locked position or an unlocked position, and wherein the second position is a locked position when the first position is an unlocked position, or an unlocked position when the first position is a locked position.

3. The actuator arrangement of claim 2, wherein the lockpin includes a first end and a second end, wherein the second end includes a recess configured to receive a protrusion of the male connector, and wherein the second end includes a shoulder portion.

4. The actuator arrangement of claim 3, wherein, when moving the lockpin from the locked position to the unlocked position, the female connector is configured to contact the shoulder portion of the second end of the lockpin, and
wherein the female connector is configured to apply a force to the shoulder portion to move the lockpin from the locked position to the unlocked position.

5. The actuator arrangement of claim 3, wherein, when moving the lockpin from the unlocked position to the locked position, the protrusion of the male connector is configured to contact the shoulder portion of the second end of the lockpin, and
wherein the protrusion of the male connector is configured to apply a force to the shoulder portion to move the lockpin from the unlocked position to the locked position.

6. The actuator arrangement of claim 4, wherein, when the lockpin is in a locked position, the recess and shoulder portion are configured to allow radial movement of the lockpin to prevent load transfer to an actuator housing.

7. A kit for connecting a lockpin to an actuator arrangement, said kit comprising:
an actuator arrangement having a female connector;
a lockpin having a male connector configured to connect to the female connector.

8. The kit of claim 7, wherein the male connector includes at least one hook and the female connector includes at least one opening and at least one groove, said at least one opening and said at least one groove configured to receive the at least one hook of the male connector.

9. The kit of claim 8, wherein the female connector includes at least one spring configured to bias the at least one hook of the male connector to the at least one groove of the female connector.

10. The kit of claim 7, the kit further comprising:
a tool configured to connect the male connector to the female connector.

11. The kit of claim 10, wherein the tool includes a first end and a second end, and wherein the first end is configured to receive the male connector.

12. The kit of claim 11, wherein the lockpin further comprises:
a central bore, and
wherein the first end of the tool is configured to insert the male connector through the central bore of the lockpin to mate with the female connector of the actuator arrangement.

13. The kit of claim 12, wherein the tool includes a handle that is configured to rotate the tool such that the male connector connects to the female connector.

14. A method of connecting a lockpin to an actuator arrangement, the method comprising:
providing a tool having a first end and a second end, wherein the tool receives a male connector at the first end;
moving the first end of the tool through a central bore of a lockpin such that the male connector engages with the female connector;
rotating the tool such that the male connector rotates to retain its position in a groove provided in the female connector;
removing the tool.

15. The method of claim 14, wherein the male connector includes at least one hook and the female connector includes at least one opening and at least one groove, said at least one opening and said at least one groove configured to receive the at least one hook of the male connector,
wherein, when the male connector engages the female connector, the at least one hook of the male connector moves through the at least one opening of the female connector, and wherein, during rotation, the at least one hook of the male connector rotates into the at least one groove of the female connector.

16. The method of claim 15, wherein the female connector includes a spring that biases the at least one hook of the male connector against the at least one groove of the female connector.
